(19) United States
(12) Patent Application Publication
(10) Pub. No.: US 2012/0318206 A1
(43) Pub. Date: Dec. 20, 2012

(54) Elevated Pet Furniture

(76) Inventor: Matthys van Leeuwen, Redmond, WA (US)

(21) Appl. No.: 13/161,366

(22) Filed: Jun. 15, 2011

(51) Int. Cl. A01K 29/00; A01K 1/035; F16M 11/00; A01K 1/03

(52) U.S. Cl. 119/416; 119/28.5; 248/163.1

(57) ABSTRACT

This invention is an elevated pet furniture that comprises a frame with the option to build other structures onto it for multipurpose use and enhanced comfort features, such as head- and backrest support or the like, or an elevated feeder structure not limited to the functions mentioned. The pet furniture includes a tubular frame, which allows for different pet furniture sizes, corners, elements such as legs or wheels that elevate the bed, and a cover body for which different material can be used for different functions or interior or exterior use. The fabric layer can be easily installed or removed without the use of tools, while keeping the frame intact for machine washing or changing for other functions or for inner or outer use, and additional functional elements can be inserted between the layer and the webbing.

### STATEMENT REGARDING FEDERALLY SPONSORED RESEARCH OR DEVELOPMENT

Not applicable

### NAMES OF THE PARTIES TO A JOINT RESEARCH AGREEMENT

Not applicable

### REFERENCE

EPF.SPEC

### FIELD OF THE INVENTION

The field of the invention relates to apparatus and method for domestic animal care, more specifically regarding bedding, housing, feeding, and/or traveling needs. The present invention is particularly well adapted to provide a resting surface with optional containment elevated from the floor or ground level to provide comfort for the pet and protect the surface from damage.

### BACKGROUND OF THE INVENTION

In many instances, a household pet is considered a family member and as such deserves comfortable accommodation and feeding instruments, especially a place to rest and sleep and a feeding area. To provide such a comfortable resting place, numerous pet beds have been referred to in the prior art. Most of these have a cushion-like design with filling, which tends not to last very long, and dogs in isolation or boredom tend to chew their beds. Apart from the inconvenience of losing a bed and the mess to clean, most fillings contain toxins that could adversely affect the animal's health. These cushions are generally placed on cold floors, creating condensation from the animal's body warmth and also an odor, resulting in rot on hardwood floors, as well as dirt and dust.

Some elevated pet beds currently on the market include the Kuranda dog bed (U.S. Pat. No. 5,992,348, November 1999, Harding—references cited) and the Durabed from PetMate (which looks similar to U.S. Pat. No. 5,960,739, October 1999, Storm—references cited). For these beds, however, the frame needs to be taken apart using tools to remove the fabric layer for washing—an activity that needs to be done regularly. If the bedding is not washed, the soiled and contaminated fabric layer becomes cold, damp, and dirty. The bedding can harbor insects, mildew, and bacteria, thereby exposing the pet to a severe health hazard. If the fabric layer is difficult to remove, an owner is discouraged from washing it very often.

Pets often prefer to sleep on a harder surface than comfortable cushions—one of the reasons they tend to choose the couch or simply the floor over their bed cushion. The elevated beds on the market mainly have fabric on the sleeping pad. Over time and when becoming wet, this fabric layer stretches, and fabric on such beds as Kuranda and Durabed cannot be re-stretched, which is crucial for providing a comfortable resting place.

Dogs tend to feel comfortable in a contained environment, and while some of the elevated beds have an overhead structure, none of them have a built-in structural environment. Some have side walls for the dog to cuddle against, but the structure does not allow strong cushioning for comfort.

### BRIEF SUMMARY OF THE INVENTION

This invention is a pet furniture structure of which a pet bed configuration is comfortable, chew resistant, easy to clean, easy to replace the fabric layer for machine wash, built on an elevated durable structure, and has an aesthetically appealing professional appearance. The furniture structure is constructed with a custom tubular frame that fits into molded plastic corner brackets, which allow a pet bed configuration to be elevated on legs or wheels and allow a housing or containment structure to be built on top. The tubular frame consists of two parts, a lower and upper profile, which allows the use of different types of fabric of different thicknesses, both for indoor and outdoor use, and constructed by sliding the fabric in between the upper and lower profiles and while closing the straps underneath the bed, the upper profile closes with the lower profile to become unified. The manner of fastening the fabric layer material onto the tubular frame makes it easy to install and replace. Installation of the fabric layer in between the tubular frame prevents the dog from chewing on the fabric as there is virtually no starting point for chewing. The fabric can be cleaned by hosing, using a lint roller or by removing it and machine washing it. Bolsters that are installed for the dog to cuddle or rest against can be easily replaced with a housing structure for indoor or outdoor use. The upper structure can be used for any other furniture structure, like an elevated feeder.

Using the aforementioned concept, a wide variety of differently configured pet beds or furniture can be manufactured. The beds do not need to be rectangular, but can also be hexagonal or any other geometric shape. Different fabrics can be used for indoor or outdoor purposes. The fabric can be easily switched to different colors when the environment changes, and several combinations of different colors and types can also be used. By changing the top structure, different types of furniture, both for dogs and cats, can be constructed. A tent structure on top, for instance, allows a dog owner to use the same bed while traveling and camping. A house-type structure allows the dog to sleep in an enclosed environment at night, while still sleeping on the same elevated bed. A water-repellant and drip-through-type textilene vinyl or other type of material can be used for an outdoor bed that blends with outdoor furniture. On the bottom portion of the structure, shorter or longer legs can be installed to better fit the environment. Wheels can be used instead of legs to easily move the bed from place to place. The same frame embodiment can be used to create an elevated feeder to make a matching design with a pet bed or other furniture.

### BRIEF DESCRIPTION OF THE DRAWINGS

For a further understanding of the nature and object of the present invention, reference should be made to the following detailed descriptions, taken in conjunction with the accompanying drawings, where like elements are given the same or analogous reference numbers and wherein:

FIG. 1 is a perspective view of an exemplary embodiment of the elevated pet furniture of the present invention;

FIG. 2 is a perspective view of the frame composition of the pet furniture of the present invention;

FIG. 3 is a side cross-sectional view of the present invention with the fabric layer without the upper structure installed;

FIG. 4 is a perspective view showing the bottom of the present invention with the fabric layer installed;

FIG. 5 is a fragmentary view showing how the elevated element is pivotally mounted into the fitting shown in FIG. 4;

FIG. 6 is a second perspective view of the elevated pet furniture of the present invention with a different top structure without the fabric layer installed.

FIG. 7 is a second perspective view of the exemplary embodiment of the elevated pet furniture of the present invention in a non-rectangular, but hexagonal shape.

### DETAILED DESCRIPTION OF THE INVENTION

This invention relates broadly to animal care accessories, especially to a resting surface for pets, potentially including housing or containment needs. This pet furniture is characterized by several attributes: it is elevated from the floor using different types of attributes, such as legs or wheels in different types or sizes. It is also lightweight. The fabric layer can be easily constructed and removed for washing or replacement and can be made of different types of material for different types of use. The edges of the fabric layer are hidden to prevent dogs from chewing on it, and the frame bracket apertures allow the construction of other upper structures for different purposes, such as the use of comfort bolsters for the animal to cuddle up against or a housing or containment unit to provide a protective contained environment for the resting animal. It also allows the same tubular frame to construct an elevated feeder. The distance between the fabric layer and the straps can be used to insert a foam layer with supporting board to increase the comfort level and to serve an orthopedic purpose or to interpose a tray for a pet with incontinency issues so that the urine drips through mesh type fabric for collection on the tray.

Constructing and removing the fabric layer from the frame structure in the present invention can be done without the need of any tools, making it convenient for the pet owner to wash and clean. The attachment of the fabric layer to the frame enables the pet owner to include a memory foam layer with supporting board to increase the comfort level for the animal.

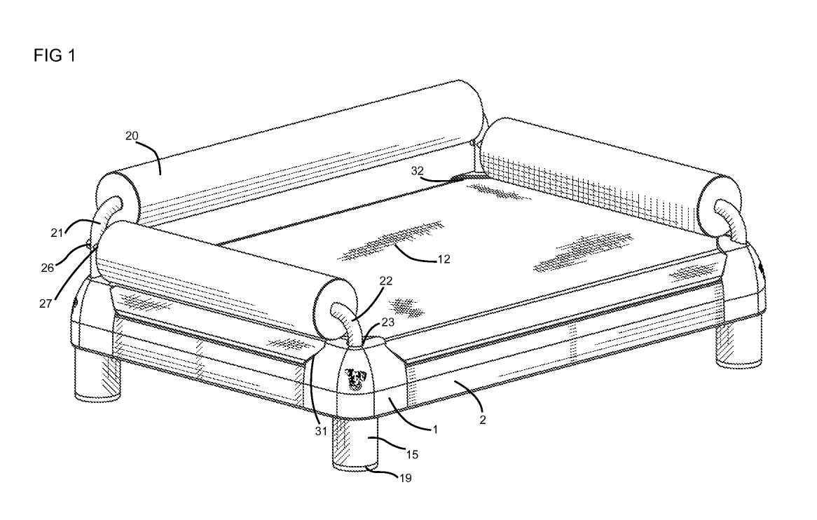

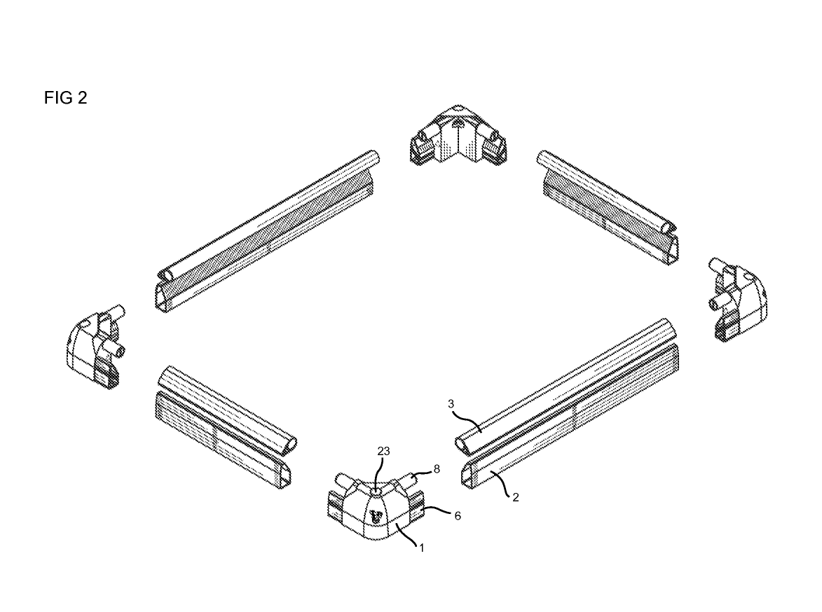

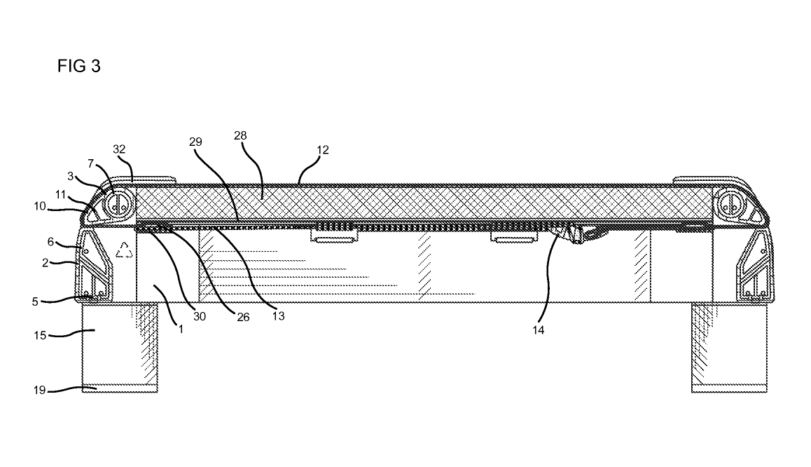

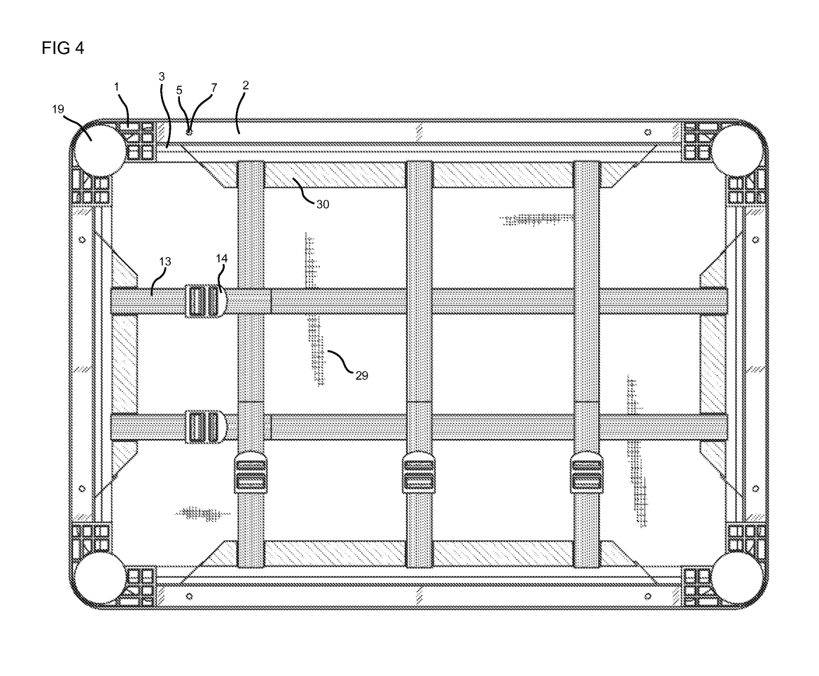

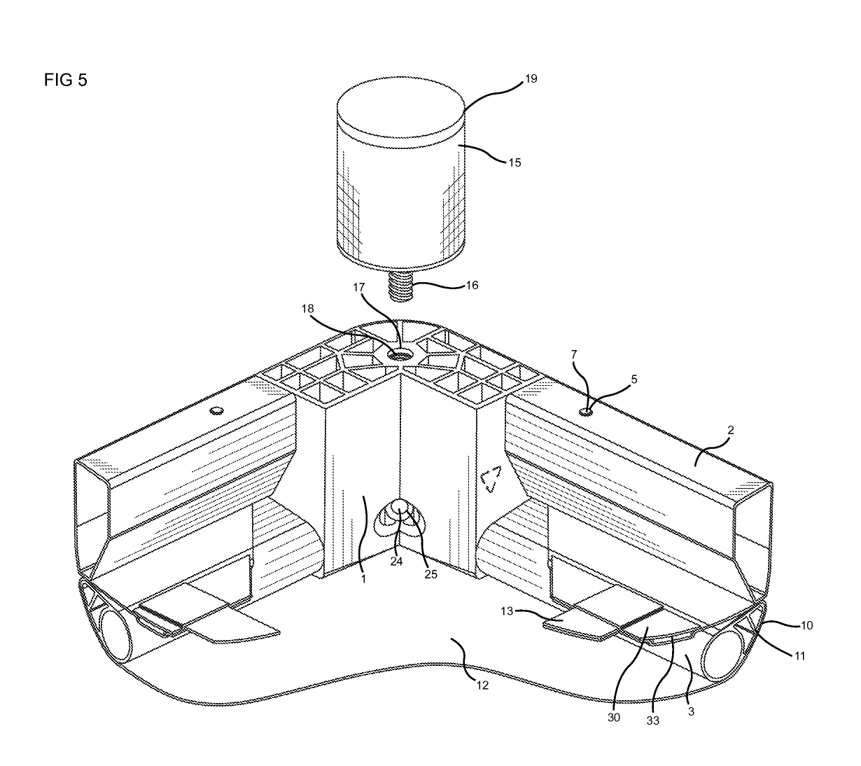

References are now made to FIGS. 1-7, depicting pet furniture in different variations of the present invention. Referring to FIG. 1 the embodiment of the invention consists of a frame, which is comprised of four sides of aluminum tubing, created by conventional molding techniques for aluminum tubing, and four molded corner brackets (1), created by conventional molding techniques for ABS-type material. Referring to FIG. 2, the four sides of frame tubes in which each side consist of a lower tube (2) and an upper tube (3) and the corner brackets (1) slide together and (referring to FIGS. 4 and 5) stay in position by the knob (5) of the corner brackets lower inserts (6), which fall into an aperture (7) at the bottom portion of the lower tube (3). With the corner brackets lower insert (5) slid into the lower frame tube (2) and the corner bracket upper insert (8) simultaneously into the upper frame tubes (3) the frame embodiment sufficiently holds animals up to 200 lbs. The upper frame tube (3) consists of a round tubular section (9) and a tear drop portion (10) with an inside slat (11). Referring to FIG. 3, when installed on the corner bracket (1) on the round shaped corner bracket upper insert (8) it allows the upper frame tube (3) to swivel. When a fabric layer (12) is installed and properly mounted using webbing (13) and buckles (14) the upper frame tube (3), with the tear drop portion (10) facing towards the top of the lower tube (2) swiveling on the round corner bracket upper insert (8), and the lower frame tube (2) merge into one side of the frame embodiment. The upper section of the frame embodiment created by the upper frame tubes (3), the corner brackets (1) with the upper inserts (8) and the fabric layer (12) hold an animal with weight up to 200 lbs. The slat (11) inside the tear drop portion (10) increases the strength of the upper section of the frame embodiment.

An important aspect of the present invention is that the fabric layer (12) can be removed or installed easily for washing or replacement without using any tools. Another benefit (see FIGS. 3 and 4) is that a (memory) foam layer (28) with supporting board (29) can be included inside the frame embodiment between the fabric layer (12) and the webbing (13) increasing the comfort level and adding an orthopedic function of the bed, while maintaining the chew resistance of the bed.

Referring to FIG. 5, the legs (15) with screw (16) or any other apparatus (such as wheels) that elevate the frame structure are pivotally mounted to the bottom aperture (17) with nut (18) inside the corner brackets (1). The legs (15) have a rubber surface (19) on the bottom to prevent scratching the floor and the pet furniture slipping when an animal jumps onto it.

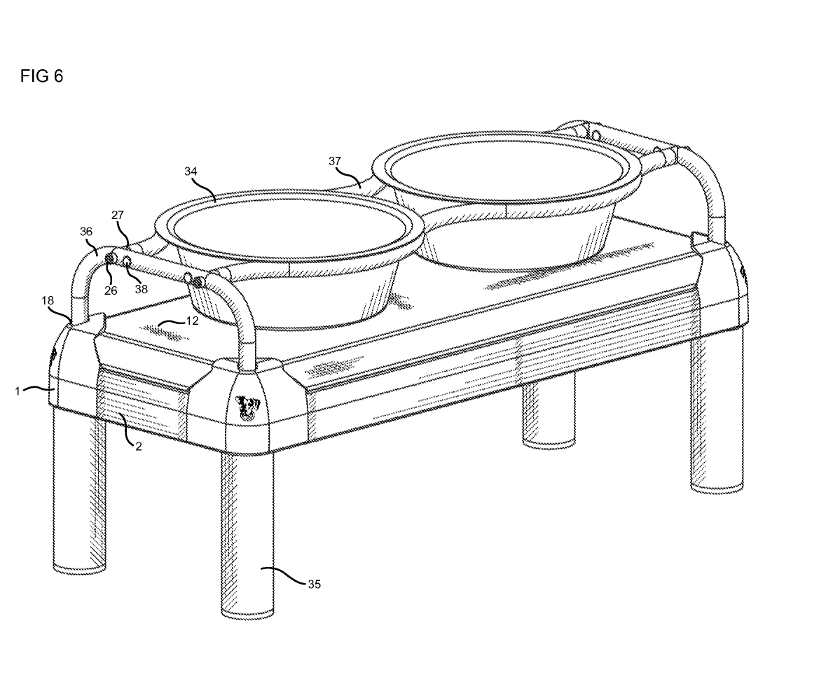

A first exemplary embodiment of the upper structure, referring to FIG. 1, providing comfort bolsters (20) is shown for the animal to cuddle up against or use as a headrest. The comfort bolsters (20) made of foam material slid onto bolster frame tubes on the back (21) and sides (22). These tubes or any other type of upper structure, as demonstrated in FIG. 6, are connected in the top aperture (23) (also referring to FIG. 2) of the corner brackets (1) and referring to FIG. 6 secured with a spring knob (24) into an aperture (25) of the inside portion of the corner brackets (1). The back frame tube (21) is connected with the side tubes (22) with a screw (26) that is pivotally mounted through the back tube (21) into a plastic end point (27) which is created by ABS molding technique and firmly connected into one end of the side frame tube (22).

Referring to FIG. 1 with the fabric layer (12) installed, the layer edges are mostly hidden in the frame embodiment between the upper frame tubes (3) and lower frame tubes (2) of the frame sides and the corners in the bracket grooves (32) of the corner brackets (1). This makes it hard for the animal to chew on the fabric layer (12), and while it is installed over the upper frame tubes (3), it is convenient to lay their head on. It also gives the entire embodiment of the invention a much better look from a styling perspective, and as the elevated pet bed is part of the pet owner's furniture, it allows a blending of colors with the entire interior or exterior.

Referring to FIGS. 1, 3 and 4, the fabric layer (12) consists of an octagonal shape with webbing (13) laterally connected to the straight outer edges (30). Two lateral sides have buckles (14) connected to each strap, so that the strap of the opposing side can be connected. The diagonal edge (31) of the fabric layer (12) aligns with the top side of the corner bracket (1) and falls into in the bracket groove (32). An even distribution of the tightness of the fabric layer is created by a strip (33) inside the straight outer edge (30) of the fabric layer (12). An evenly tight fabric layer (12) will make it more convenient for the animal stepping onto it, as that will create more pressure on that particular spot. Removing can be simply done by releasing the webbing (13) from the buckles (14) and taking it out of the frame embodiment by swiveling the upper frame tubes (3) upward in the frame embodiment. Unlike other elevated pet beds on the market, the bed frame does not have to be taken apart. Replacing the fabric layer (12) is easy if taste in color changes, if the fabric suffers wear, or if a change in the environment occurs, such as using the bed outside with a fabric that is water repellant or using a fabric where the water can drip through or for a dog with incontinency issues so that the urine or water drips through to a tray in between the fabric layer (12) and webbing (13) inside the frame embodiment.

Another top structure of the present invention, referring to FIG. 6, is shown with a structure holding pet bowls (34) functioning as an elevated feeder elevated by a different size legs (35) to create a feeding comfort level for the animal. The upright structure frame tubes (36) are installed in the top apertures (18) of the corner brackets (1). The beams (37) are joined with screws (26) using plastic end points (27) to connect them. Inside the frame tubes two pet bowls (34) can be placed and with moving the frame tubes (36) inward by connecting to the other two apertures (38) smaller pet bowls can be placed onto the same structure. The fabric layer (12) prevents spilling of food and water on the floor and serves also as decorative function and does need to hold anything as the pet bowls are placed in an upper structure embodiment above it. Referring to FIGS. 1, 3 and 4 the fabric is installed the same way with the lower frame tubes (2) of the frame embodiment visible slid into the corner brackets (1). Referring to FIG. 5, the upright frame tube structure is secured with spring knobs (24) that go into the apertures (25) in the inside of each corner bracket (1).

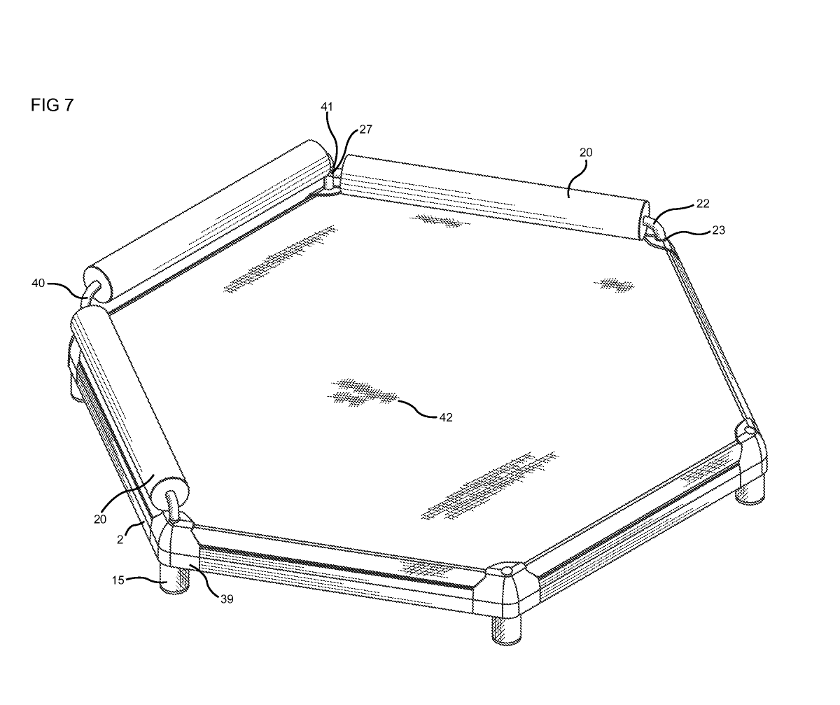

Referring to FIG. 7, another perspective of the present invention is shown with six frame sides within the frame embodiment and diagonally shaped corner brackets (39) to accommodate the hexagonal shape of the present invention. These diagonally shaped corner brackets (39) have the same design and function, yet a different shaped corner. Referring to FIGS. 1, 3 and 4 the fabric is installed the same way with the lower (2) and upper frame tubes of the frame embodiment slid into said diagonally shaped corner brackets (39). The frame embodiment is elevated by six legs (15). Referring to FIG. 1 an upper structure with back (40) and side tubes (22) with comfort bolsters (20) is installed in the top aperture (23) of the diagonally shaped corner brackets (39) in line with the hexagonal shape of the frame embodiment. The aperture (41) in the back tube of the upper structure points diagonally to support the side tube (22). Referring to FIGS. 1 and 7, the back frame tube (40) is connected with the side tubes (22) with a screw (26) that is pivotally mounted through the aperture (41) in the back tube (40) into a plastic end point (27) which is firmly connected into one end of the side frame tube (22). Referring to FIG. 5, the upright frame tube structure is secured with spring knobs (24) that go into the apertures (25) in the inside of each diagonally shaped corner bracket (39). The fabric layer (42) fits into the hexagonal shape.

While the present invention has now been described and illustrated with some specificity in two different upper structure variations and elevation variations, the various modifications, variations, additions, and omissions can be especially appreciated. Accordingly, it is intended that these modifications also be encompassed by the present invention, and that the scope of the present invention be limited solely by the broadest interpretation that lawfully can be accorded the stated claims.

What is claimed is:

1. an elevated pet furniture, comprising:
a structural frame consisting of frame tubes and corner brackets, where said corner brackets are fitted into said frame tubes together to erect a structural furniture frame, with a knob that slides into a frame hole;
a fabric layer connected to said structural furniture frame that slides in between an upper and lower portion of the frame tube is enclosed by straps, with optional foam and supporting board in between, to make it suitable to hold an animal;
an element that elevates said structural furniture frame, where said element is either legs or wheels pivotally mounted to the bottom portion of said corner brackets;
an installable upper structure of a pair of tubes and cover elements.

2. the elevated pet furniture of claim 1, wherein:
said fabric layer is secured to the said structural furniture frame by sliding said fabric layer fabric in between the upper and lower section of the frame tubes, where the upper tube of the said frame tubes swivels to merge with the lower tube and the corners in grooves in the said corner brackets.

3. the elevated pet furniture of claim 2, wherein:
the distance between said fabric layer, installed in said frame tubes, and the webbing allow a functional layer in between said fabric layer and webbing.

4. the elevated pet furniture of claim 2, wherein:
said fabric layer is installed over the frame tube edges.

5. the elevated pet furniture of claim 2, wherein:
said fabric layer is selectively removable and replaceable for different functions indoors or outdoors without disassembling said structural furniture frame.

6. the elevated pet furniture of claim 1, wherein:
said installable upper structure adds to the comfort or provides a containment or housing function or creates a feeding area to said pet furniture.

7. the elevated pet furniture of claim 6, wherein:
said installable upper structure is installed inside apertures of said corner brackets and secured with a spring knob to said corner brackets.
